(19) United States
(12) Patent Application Publication
(10) Pub. No.: US 2012/0017779 A1
(43) Pub. Date: Jan. 26, 2012

(54) CORN KERNELER

(76) Inventors: Tony J. Abfall, Mt. Prospect, IL (US); Michael R. Mastroianni, Crystal Lake, IL (US); David M. Waskin, Palatine, IL (US); Aurelio Reyes, Sugar Grove, IL (US); John R. Visk, Chicago, IL (US)

(21) Appl. No.: 12/839,660

(22) Filed: Jul. 20, 2010

(51) Int. Cl. A47J 43/04

(52) U.S. Cl. 99/538

(57) ABSTRACT

A corn kerneler having a cutting apparatus including an expandable, ring-shaped blade. The corn kerneler further includes a housing supporting the cutting apparatus and cooperating with the blade to form a substantially enclosed kernel collection chamber.

### BACKGROUND

The present invention relates to a corn kerneler utensil for removing kernels of corn from a cob.

Many individuals who enjoy consuming corn dislike or are unable to bite corn kernels directly off of the cob. Therefore, it is common for a consumer to cut the kernels off of the cob after the ear of corn has been cooked. However, it may be difficult to grasp the ear of corn, operate the cutting utensil, and contain the kernels in a desired area as they are removed from the cob.

Many products have been introduced that attempt to simplify the corn kernel removal process, but all suffer from one or more of poor performance, difficulty in operating, and lack of a convenient integrated means for containing and dispensing the corn kernels removed from the cob.

### SUMMARY

In one embodiment, the invention provides a corn kerneler having a cutting apparatus including an expandable, ring-shaped blade. The corn kerneler further includes a housing supporting the cutting apparatus and cooperating with the blade to form a substantially enclosed kernel collection chamber.

In another embodiment, the invention provides a corn kerneler having a housing including an inlet opening and an outlet opening, the inlet opening and the outlet opening being substantially coaxial to allow passage of an ear of corn through the housing. The corn kerneler further includes a cutting apparatus positioned within the housing. The cutting apparatus includes a blade having a cutting edge adjacent the inlet opening. The cutting apparatus is supported within the housing such that the blade is radially surrounded by the housing with the cutting edge axially recessed from the inlet opening.

In yet another embodiment, the invention provides a corn kerneler including a support structure and a cutting apparatus supported by the support structure. The cutting apparatus includes a ring-shaped blade expandable between a retracted position and an expanded position. The blade includes two semi-circular portions interconnected with at least one sliding joint to allow expansion and contraction of the blade about an axis. The cutting apparatus further includes a plurality of flexible supports coupled to both the support structure and the blade to elastically support the blade with the support structure. The plurality of flexible supports bias the blade to the retracted position.

Other aspects of the invention will become apparent by consideration of the detailed description and accompanying drawings.

### BRIEF DESCRIPTION OF THE DRAWINGS

FIG. 1 is a perspective view of a corn kerneler according to one embodiment of the present invention.

FIG. 2 is an alternate perspective view of the corn kerneler of FIG. 1.

FIG. 3 is an exploded assembly view of the corn kerneler of FIG. 1.

FIG. 4 is a bottom view of the corn kerneler of FIG. 1 with a bottom housing portion removed and a cutting assembly in a first condition.

FIG. 5 is a bottom view of the corn kerneler of FIG. 1 with a bottom housing portion removed and a cutting assembly in a second, expanded condition.

FIGS. 6A-6C illustrate a method of using the corn kerneler of FIG. 1 to remove, collect, and dispense corn kernels.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

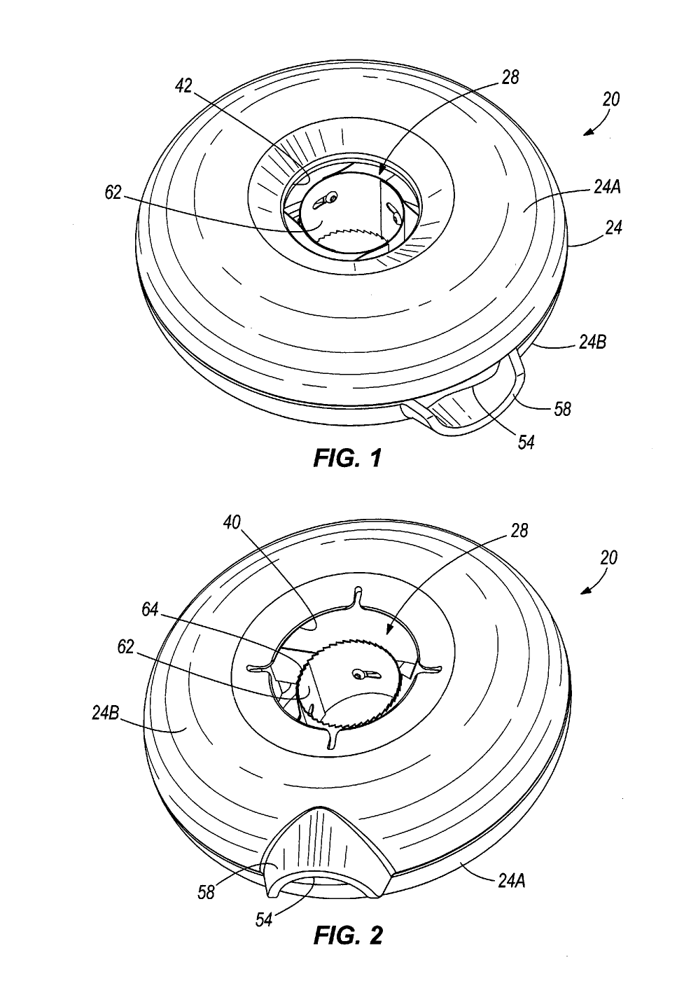

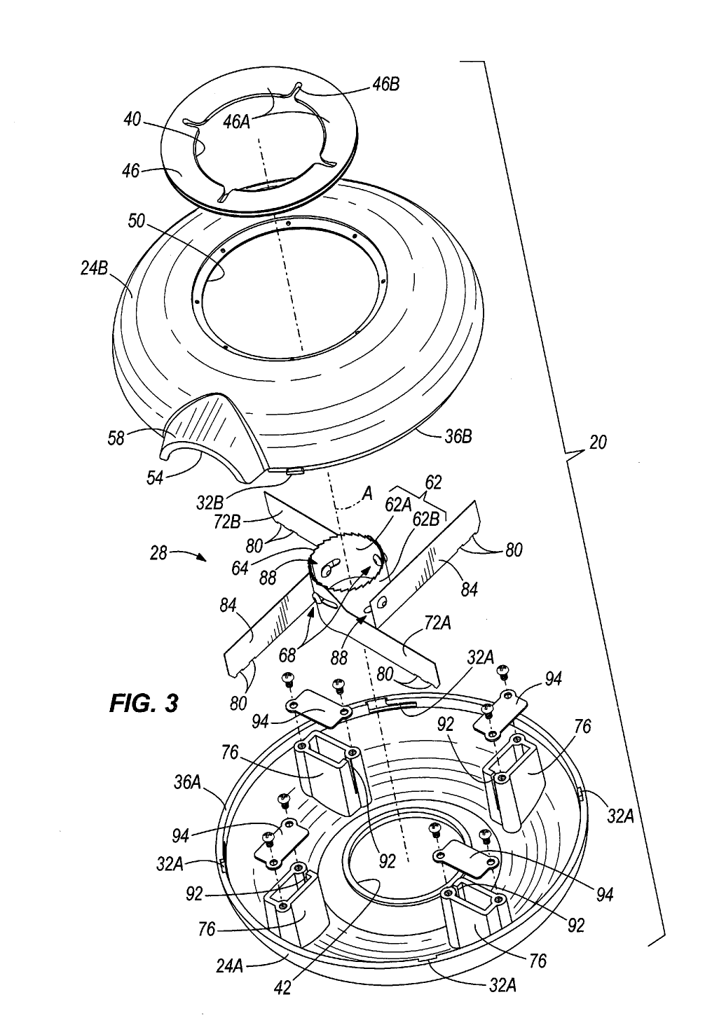

FIGS. 1-6C illustrate a corn kerneler 20 for removing corn kernels K from a cob C and for containing the removed kernels K for controlled dispensing. The corn kerneler 20 is generally annular in shape, defining a central axis A (FIG. 3). As described in further detail below, the corn kerneler 20 includes a support structure such as a housing 24 and a cutting apparatus 28. The cutting apparatus 28 is supported by the housing 24. In some constructions, such as the illustrated construction, the cutting apparatus 28 is supported by the housing 24 and also positioned substantially within the housing 24.

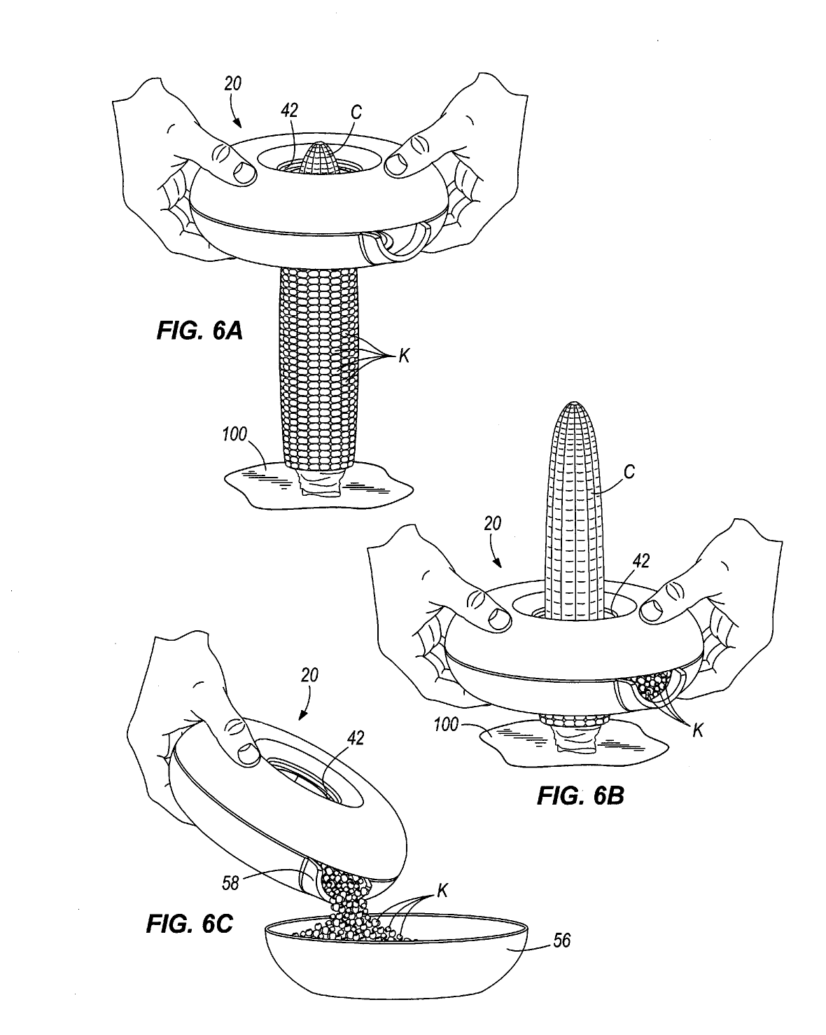

The housing 24 includes an upper housing portion 24A and a lower housing portion 24B that are selectively engageable together to substantially enclose the cutting apparatus 28 and define a substantially enclosed containment chamber for the corn kernels K. It should be noted that the terms “upper” and “lower” are used with reference to the operational orientation shown in FIGS. 6A and 6B, and should not be otherwise limiting to the invention. In the illustrated construction, the upper and lower housing portions 24A, 24B are connectable with a plurality of circumferentially-spaced bayonet-type connectors 32A, 32B on their respective mating peripheral rims 36A, 36B. The connectors 32A of the upper housing portion 24A include L-shaped slots, and the connectors 32B of the lower housing portion 24B include projections or tabs that are axially receivable into the respective L-shaped slots 32A. The upper and lower housing portions 24A, 24B are securely locked together upon a slight rotation therebetween that seats the tabs 32B into the L-shaped slots 32A to prevent axial separation. Likewise, the upper and lower housing portions 24A, 24B are easily unlocked and separable from one another by only a slight counter-rotation. This allows quick, easy access to the cutting apparatus 28 between uses (e.g., for cleaning, etc.). In some constructions, the relative rotation between the upper and lower housing portions 24A, 24B for locking or unlocking is only about 10 degrees about the axis A.

The housing 24 is configured to allow passage of a corn cob C therethrough. Particularly, in the illustrated construction, the lower housing portion 24B is provided with an inlet opening 40 and the upper housing portion 24A is provided with an outlet opening 42. The inlet and outlet openings 40, 42 are substantially coaxial with each other and with the axis A. The inlet opening 40 is formed at least in part by an elastomeric material. As shown in FIG. 3, an elastomeric ring 46 is over-molded into an opening 50 in the lower housing 24B in the illustrated construction. The elastomeric ring 46 includes a plurality of flaps 46A, adjacent pairs of which are separated by slits 46B. The elastomeric ring 46 enables the inlet opening 40 to tightly hug ears of corn of various sizes while inhibiting the collected corn kernels K from falling out of the inlet opening 40.

The lower housing portion 24B further includes a dispensing opening 54. The dispensing opening 54 is in communication with the interior chamber of the housing 24 to allow controlled dispensing of collected corn kernels K out from the housing 24 to a desired location or receptacle 56 (FIG. 6C), such as a plate, bowl, or storage container. In the illustrated construction, the dispensing opening 54 is formed with a spout 58.

The cutting assembly 28, best shown in FIG. 3, includes an expandable, ring-shaped blade 62. The blade 62 may be formed of metal, such as stainless steel or spring steel, and includes a cutting edge 64, which may be serrated. The blade 62 is positioned substantially between the inlet opening 40 and the outlet opening 42 with the cutting edge 64 adjacent the inlet opening 40 as shown in FIG. 2. The cutting apparatus 28 is supported within the housing 24 such that the blade 62 is radially surrounded by the housing 24 with the cutting edge 64 axially recessed from the inlet opening 40. The blade 62 cooperates with the housing 24 to define the substantially enclosed kernel collection chamber when the upper and lower housing portions 24A, 24B are engaged together. The kernel collection chamber is substantially annular and bounded by the blade 62 on the radially inward side, the upper housing portion 24A on one axial end, the lower housing portion 24B on the other axial end, and by both the upper and lower housing portions 24A, 24B on the radially outer side.

The ring formed by the blade 62 is not formed of one continuous piece, but rather two opposing and overlapping semi-circular portions 62A, 62B that are interconnected with at least one sliding joint 68 to allow expansion and contraction of the blade 62 about the axis A. The semi-circular blade portions 62A, 62B are coupled with two sliding joints 68 in the illustrated construction. Each of the semi-circular blade portions 62A, 62B is integrally-formed with a flexible support 72A, 72B. The supports 72A, 72B extend substantially tangentially from the respective blade portions 62A, 62B and are fixed to the housing 24. In the illustrated construction, the upper housing portion 24A includes receptacles 76 for receiving the radially outer ends of the respective supports 72A, 72B. Each receptacle 76 engages one or more engagement features such as a pair of notches 80 formed in the corresponding support 72A 72B so that the supports 72A, 72B are held fixed relative to the housing 24 at their radially outer ends.

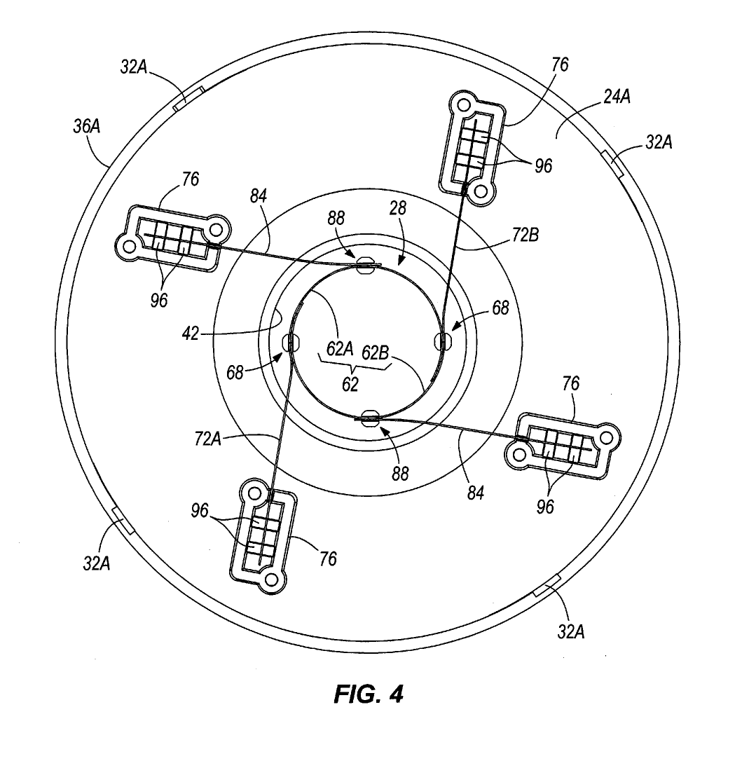

As shown in FIG. 3, the cutting apparatus 28 further includes two additional flexible supports 84, each having a radially inner end coupled to one of the semi-circular blade portions 62A, 62B with at least one sliding joint 88. The additional supports 84 may be constructed of metal, such as stainless steel or spring steel, in some constructions. The radially outer ends of the additional supports 84 are fixed to additional receptacles 76 of the housing 24 in the same manner as described above with respect to the integral flexible supports 72A, 72B. The two integral supports 72A, 72B and the two additional supports 84 are circumferentially alternating with each other and are angularly spaced at substantially even 90 degree intervals about the axis A as best shown in FIGS. 3 and 4. All of the sliding joints 68, 88 include a rivet and slot in the illustrated construction, but other arrangements for enabling blade expansion are also contemplated.

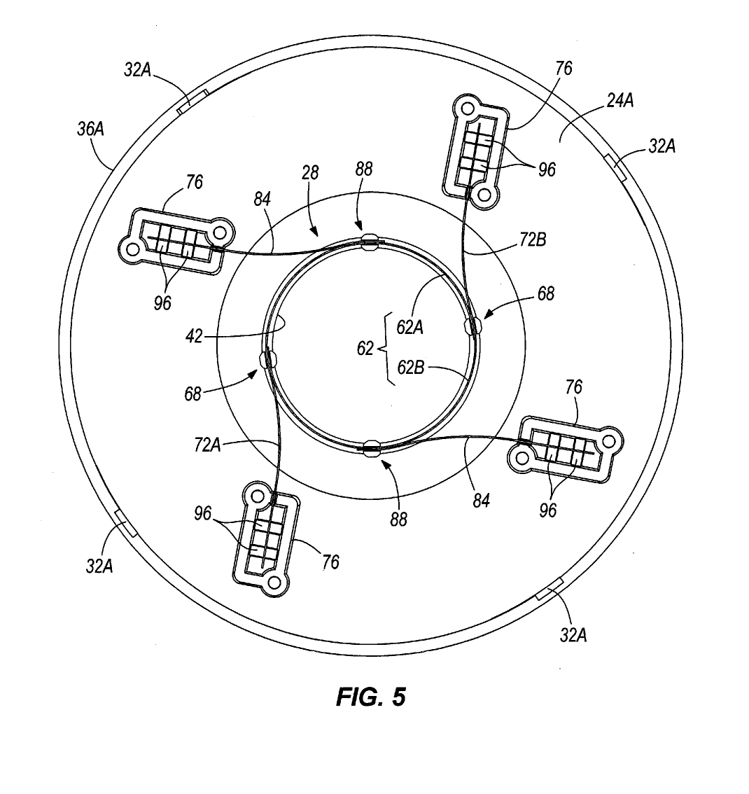

As shown in FIGS. 3-5, each of the receptacles 76 in the upper housing portion 24A receives the corresponding support 72A, 72B, 84 in a narrow slit 92 formed therein. A cover 94 is screwed or otherwise fastened to each receptacle 76 to retain the supports 72A, 72B, 84 in the axial direction (the covers 94 are removed in FIGS. 4 and 5). Within each receptacle 76 are one or more engagement features such as a pair of ribs 96 that engage with the notches 80 of the corresponding support 72A, 72B, 84. Although the receptacles 76 are described as each including ribs or male features that fit into the notches 80 (i.e., female features) formed in the corresponding supports 72A, 72B, 84, it should be understood that the male and female features may also be reversed. Furthermore, each of the supports 72A, 72B, 84 and each of the receptacles 76 may be provided with an alternate configuration of ribs and slots or may be provided with alternate types of engagement features.

FIGS. 6A-6C illustrate one manner of using the corn kerneler 20 described above. With the upper housing portion 24A oriented upwardly, the user places the kerneler 20 over the top end of an ear of corn, which is stood upright on a support surface 100 as shown. Prior to operation, the cutting apparatus 28 is spring-biased to the at-rest state shown in FIG. 4 in which the blade 62 assumes a small diameter configuration. The ear of corn is received into the inlet opening 40 and assumes a position coaxial with the axis A of the kerneler 20. The user then presses the kerneler 20 downward along the axis A toward the opposite or bottom end of the ear of corn, which is supported on the surface 100. As the kerneler 20 moves downward, the blade 62 expands as shown in FIG. 5 via the sliding joints 68, 88 to accommodate the size of the cob C. The kernels K are removed from the cob C and collected inside the housing 24, and the kernel-stripped cob C exits the kerneler 20 through the outlet opening 42. The housing 24, or at least the upper housing portion 24A, is made of a transparent or translucent material (e.g., a non-opaque plastic) in some constructions so that the cutting action and/or the kernels K collected in the chamber can be viewed. Once the entire cob C is stripped of its kernels K, the kerneler 20 is removed from the cob C, and the collected kernels K can be dispensed into the receptacle 56 via the dispensing opening 54 and the spout 58.

Various features and advantages of the invention are set forth in the following claims.

What is claimed is:

1. A corn kerneler comprising:
a cutting apparatus including an expandable, ring-shaped blade; and
a housing supporting the cutting apparatus and cooperating with the blade to form a substantially enclosed kernel collection chamber.

2. The corn kerneler of claim 1, wherein the housing includes a first portion having an inlet opening and a second portion having an outlet opening substantially coaxial with the inlet opening to allow passage of an ear of corn through the housing, the inlet opening being formed at least in part by an elastomeric material.

3. The corn kerneler of claim 2, wherein the blade includes a cutting edge, the blade being positioned substantially between the inlet opening and the outlet opening with the cutting edge adjacent the inlet opening.

4. The corn kerneler of claim 3, wherein the cutting apparatus is supported within the housing such that the blade is radially surrounded by the housing with the cutting edge axially recessed from the inlet opening.

5. The corn kerneler of claim 1, wherein the blade includes two semi-circular portions interconnected with at least one sliding joint to allow expansion and contraction of the blade about an axis.

6. The corn kerneler of claim 5, further comprising a first flexible support integrally-formed with a first one of the two semi-circular blade portions and a second flexible support integrally-formed with a second one of the two semi-circular blade portions, wherein each of the first and second flexible supports extends substantially tangentially from the blade and is fixed to the housing.

7. The corn kerneler of claim 6, further comprising two additional flexible supports fixed to the housing, each of the additional flexible supports being coupled to one of the semi-circular blade portions with at least one sliding joint.

8. The corn kerneler of claim 7, wherein the first, the second, and the two additional flexible supports are angularly spaced at substantially even 90 degree intervals about the axis.

9. The corn kerneler of claim 1, wherein the housing includes a dispensing opening in communication with the kernel collection chamber.

10. The corn kerneler of claim 9, wherein the dispensing opening is formed with a spout.

11. The corn kerneler of claim 1, wherein the housing cooperates with the blade to define the substantially enclosed kernel collection chamber when separately-formed portions of the housing are engaged together, the housing providing access to the cutting apparatus when the separately-formed housing portions are disengaged.

12. A corn kerneler comprising:
a housing including an inlet opening and an outlet opening, the inlet opening and the outlet opening being substantially coaxial to allow passage of an ear of corn through the housing; and
a cutting apparatus positioned within the housing, the cutting apparatus including a blade having a cutting edge adjacent the inlet opening, wherein the cutting apparatus is supported within the housing such that the blade is radially surrounded by the housing with the cutting edge axially recessed from the inlet opening.

13. The corn kerneler of claim 12, wherein the housing cooperates with the blade to form a substantially enclosed kernel collection chamber.

14. The corn kerneler of claim 13, wherein the housing further includes a dispensing opening in communication with the kernel collection chamber.

15. The corn kerneler of claim 14, wherein the dispensing opening is formed with a spout.

16. The corn kerneler of claim 12, wherein the blade is an expandable, ring-shaped blade including two semi-circular portions interconnected with at least one sliding joint to allow expansion and contraction of the blade about an axis.

17. The corn kerneler of claim 16, further comprising a first flexible support integrally-formed with a first one of the two semi-circular blade portions and a second flexible support integrally-formed with a second one of the two semi-circular blade portions, wherein each of the first and second flexible supports extends substantially tangentially from the blade and is fixed to the housing.

18. The corn kerneler of claim 17, further comprising two additional flexible supports fixed to the housing, each of the additional flexible supports being coupled to one of the semi-circular blade portions with at least one sliding joint.

19. The corn kerneler of claim 18, wherein the first, the second, and the two additional flexible supports are angularly spaced at substantially even 90 degree intervals about the axis

20. The corn kerneler of claim 12, wherein the inlet opening is formed at least in part by an elastomeric material.

21. The corn kerneler of claim 12, wherein the housing includes separately-formed portions engageable together to substantially enclose the cutting apparatus, the housing providing access to the cutting apparatus when the separately-formed housing portions are disengaged.

22. A corn kerneler comprising:
a support structure; and
a cutting apparatus supported by the support structure, the cutting apparatus including
a ring-shaped blade expandable between a retracted position and an expanded position, the blade including two semi-circular portions interconnected with at least one sliding joint to allow expansion and contraction of the blade about an axis, and
a plurality of flexible supports coupled to both the support structure and the blade to elastically support the blade with the support structure, the plurality of flexible supports biasing the blade to the retracted position.

23. The corn kerneler of claim 22, wherein the plurality of flexible supports includes a first flexible support integrally-formed with a first one of the two semi-circular blade portions and a second flexible support integrally-formed with a second one of the two semi-circular blade portions, wherein each of the first and second flexible supports extends substantially tangentially from the blade and is fixed to the support structure.

24. The corn kerneler of claim 23, further comprising two additional flexible supports fixed to the support structure, each of the additional flexible supports being coupled to one of the semi-circular blade portions with at least one sliding joint.

25. The corn kerneler of claim 24, wherein the first, the second, and the two additional flexible supports are angularly spaced at substantially even 90 degree intervals about the axis

26. The corn kerneler of claim 22, wherein the support structure includes a housing that cooperates with the blade to form a substantially enclosed kernel collection chamber, the housing including a dispensing opening in communication with the kernel collection chamber.

27. The corn kerneler of claim 26, wherein the dispensing opening is formed with a spout.

28. The corn kerneler of claim 22, wherein the support structure includes a housing that substantially encloses the cutting apparatus, the housing including separately-formed portions disengageable from each other to selectively provide access to the cutting apparatus when the separately-formed housing portions are disengaged.
